(19) United States
(12) Patent Application Publication
(10) Pub. No.: US 2015/0068987 A1
(43) Pub. Date: Mar. 12, 2015

(54) FILTRATION SYSTEMS FOR FAUCETS

(71) Applicant: 3M INNOVATIVE PROPERTIES COMPANY, St. Paul, MN (US)

(72) Inventors: Laurence W. Bassett, Killingworth, CT (US); Thomas J. Hamlin, Vernon, CT (US); Robert E. Astle, Middlefield, CT (US)

(21) Appl. No.: 14/479,503

(22) Filed: Sep. 8, 2014

Related U.S. Application Data
(60) Provisional application No. 61/875,262, filed on Sep. 9, 2013.

(51) Int. Cl. B01D 35/04; C02F 1/28; B01D 41/04; C02F 1/00

(52) U.S. Cl. CPC B01D 35/04; C02F 1/003; C02F 1/283; B01D 41/04; C02F 2307/06; C02F 2201/006; C02F 2201/005; C02F 2301/04
USPC 210/767; 210/433.1; 210/483; 210/484; 29/428; 29/402.04

(57) ABSTRACT

Fluid filtration systems that have openings in their sump closures are provided. Spouts for processed fluid may be added to direct flow of processed fluid. The spouts may be attached, permanently or removably, to the sump closures or to media cartridges. The system comprises: an inlet, an unprocessed fluid outlet, and a processed fluid outlet; a sump housing and a sump closure operatively associated therewith, the processed fluid outlet being located through the sump closure; a media cartridge located in the sump housing, the media cartridge providing processed fluid upon contact with unprocessed fluid; and a diverter. Flow of processed fluid may be directed through any desired angle when a rotatable structure is included in the system. Filtration systems may easily be cleaned and/or sanitized.

### CROSS-REFERENCE TO RELATED APPLICATIONS

This application claims priority under 35 U.S.C. §119(e) to U.S. Patent Application Ser. No. 61/875,262, filed Sep. 9, 2013, which is hereby incorporated by reference in its entirety.

### TECHNICAL FIELD

This disclosure relates to fluid filtration systems for faucets. Specifically, these systems for water filtration contain a sump closure with an opening for processed fluid. Spouts may be further added to direct flow out of the opening. Methods of making and using the same are also provided.

### BACKGROUND

Faucet-mounted water filtration devices are common and use a variety of filtration technologies. A housing for the faucet-mounted filtration devices has several functions including the following: connection to an existing sink faucet by means of, for example, threaded adaptors; an unfiltered/unprocessed tap water bypass through a high flow outlet and/or spout; a diverter valve that changes the water flow from bypass to filtered/processed water mode; a pressure vessel or sump along with a closure that contains a filter cartridge; a filtered/processed water outlet and/or spout from which filtered/processed water exits the device to a consumer's final needs.

End-of-faucet water filtration devices may receive either drop-in replacement filter cartridges or fully encapsulated filter cartridges that connect to a permanent water filter housing. A typical water filter housing provides for attachment to the faucet, where flow through the diverter valve may be directed to the tap water (unfiltered or unprocessed) outlet and/or spout, or to a filtered or processed water outlet and/or spout. Although spent filter cartridges are routinely replaced, the filtered water spout typically stays with the water filter housing for the life of the product. Filtered or processed water outlets and/or spouts usually involve a path, i.e., a conduit or tubing, from inner diameter (ID) that is an outlet of a media or filter cartridge back through the system to a location that is accessible by a consumer. Usually the ID outlet is at the top of the cartridge because the bottom of the cartridge is sealed to the sump closure.

There is a continuing need to provide faucet-mounted water filtration devices and cartridges therefor that are easy to use and assemble, and that may be readily cleaned and/or sanitized.

### SUMMARY

Provided are fluid filtration systems for faucets that easily supply processed fluid, such as filtered water, to consumers, and that are readily able to be cleaned and/or sanitized. In recognizing that faucet-mounted filtration devices may be subjected to various types of contamination based on their locations at kitchen sinks, it has been found that providing devices with easy-to-clean and/or disposable water spouts helps to facilitate good hygiene. Moreover, providing devices whose housings are positionable permits ways to easily clean sump closures and water outlets/spouts that may be exposed to splash-up from the sink. Such positionable housings also permit easy replacement of spent media, or specifically, filter cartridges with new, clean cartridges. In addition, positioning the housing may permit their use as drinking fountains. Further, faucet-mounted filtration systems are readily disassembled from the faucet and/or their components are readily removed for replacement and/or cleaning and/or sanitizing.

In the prior art, the use of a path from the inner diameter (ID) of a media or filter cartridge to another location to provide accessibility of the processed water leads to extra cost, to more components to handle during assembly and disassembly, and to more locations for possible leaks. The use of an opening for processed fluid that is directly in the sump closure reduces the number of components needed and the associated costs and routes for leaks. The media or filter cartridge may then be fabricated with a top end cap that is non-flowing and the bottom end cap is in fluid communication with the ID and with the opening in the sump closure. The sump closure itself is readily removable for cleaning and/or sanitizing.

In an aspect, fluid filtration systems for faucets comprise: an inlet, an unprocessed fluid outlet, and a processed fluid outlet; a sump housing and a sump closure operatively associated therewith, the processed fluid outlet being located through the sump closure; a media cartridge located in the sump housing, the media cartridge providing processed fluid upon contact with unprocessed fluid; and a diverter having a first position where the inlet is in fluid communication with the unprocessed fluid outlet, and a second position where in the inlet is in fluid communication with the processed fluid outlet.

Other features that may be used individually or in combination with aspects disclosed herein are as follows. The fluid filtration system may further comprise a processed fluid spout that directs flow of processed fluid. The processed fluid spout may be attached, integrally or removably, to the sump closure, defining the processed fluid opening. The process fluid spout may be attached, integrally or removable, to the media cartridge, for example, to one of its end caps. The spout may be disposable. The processed fluid spout may comprise a movable joint that permits adjusting the direction of the flow of the processed fluid.

The sump closure may be attached, integrally or removably, to a media element of the media cartridge. The media cartridge may comprise a media element, a first end cap sealed to the media element, and a second end cap comprising the sump closure sealed to the media element and comprising a sealing mechanism that operatively engages with the sump housing.

The systems may further comprise a bridge between the faucet connection and the sump housing. The bridge may comprise a rotatable structure to permit positioning of the sump housing to any desired position. For example, in a first position, flow of processed fluid from the processed fluid outlet is in the same direction as flow of unprocessed fluid from the unprocessed fluid outlet. In a second position, flow of processed fluid from the processed fluid outlet is in the opposite direction as flow of unprocessed fluid from the unprocessed fluid outlet. In a third position, the sump housing is located at any angle between the first position and the second position.

A detailed aspect provides media cartridges for use in sump housings of fluid filtration systems for faucets. In an embodiment, the media cartridges comprise: a media element; a first end cap sealed to the media element; a second end cap comprising a sump closure sealed to the media element, a processed fluid outlet, and a sealing mechanism that operatively engages with a sump housing upon installation into the fluid filtration system. This media cartridge may further comprise a processed fluid spout in fluid communication with the processed fluid opening.

In another embodiment, the media cartridges comprise: a media element; a first end cap sealed to the media element; a second end cap sealed and comprising a processed fluid spout and a seal that operatively engages with a processed fluid outlet of a sump closure upon installation into the fluid filtration system.

In a non-limiting embodiments, either media cartridge comprises comprises a carbon-based filter block wrapped with a nonwoven layer of media as its media element. In addition, in either embodiment, the processed fluid spout may be either removable from the end cap or integral thereto.

Another aspect provides a method for providing a processed fluid, the method comprising: flowing an unprocessed fluid through a filtration system disclosed herein; and obtaining the processed fluid from the filtration system. The method may further comprise attaching a processed fluid spout to the sump closure or to the media cartridge and/or detaching the processed fluid spout from the sump closure or to the media cartridge. The fluid filtration system may further comprise a bridge between the faucet connection and the sump housing, the bridge comprising a rotatable structure. The methods may further comprise: positioning the sump housing to a first position a first position where flow of processed fluid from the processed fluid outlet is in the same direction as flow of unprocessed fluid from the unprocessed fluid outlet and/or positioning the sump housing to a second position where flow of processed fluid from the processed fluid outlet is in the opposite direction as flow of unprocessed fluid from the unprocessed fluid outlet and/or positioning the sump housing to an angle relative to the direction of flow of unprocessed fluid from the unprocessed fluid outlet. The spout may further comprise a movable joint, and the method may further comprise positioning the spout to adjust the direction of the flow of processed fluid.

Further method steps may comprise: locating in the sump housing: a media cartridge that comprises the media element, a first end cap sealed to the media element, and a second end cap comprising the sump closure sealed to the media element, and comprising a sealing mechanism; and operatively engaging the sealing mechanism with the sump housing. Other further method steps may comprise: locating in the sump housing: a media cartridge that comprises the media element, a first end cap sealed to the media element, and a second end cap sealed to the media element and comprising a processed fluid spout; installing the sump closure, which further comprises a sealing mechanism, such that the processed fluid spout extends through the process fluid outlet; and operatively engaging the sealing mechanism with the sump housing.

In another aspect, a method of making a fluid filtration system comprises: obtaining a sump housing and a sump closure operatively associated therewith, the sump closure comprising a processed fluid outlet therethrough and a sealing mechanism; locating a media cartridge comprising a media element, a first end cap, and a second end cap in the sump housing; and engaging the sealing mechanism with the sump housing. The sump closure and the sealing mechanism may form the second end cap of the media cartridge, with a processed fluid spout being optionally integral or removable to the second end cap. Or, the sump closure may comprise the sealing mechanism while the second end cap may further comprise a processed fluid spout.

Other aspects provide methods of maintaining fluid filtration systems of faucets, the methods comprising: disassembling the fluid filtration system from the faucet and/or removing components from the fluid filtration system; cleaning and/or sanitizing the fluid filtration or any of the components; and reinstalling the fluid filtration system with the faucet and/or reassembling the components of the fluid filtration system. The cleaning and/or sanitizing step may be conducted by any of the following: contacting the fluid filtration system with hot water from the faucet, placing the fluid filtration system in boiling water, and putting the fluid filtration system through a cycle of a dishwasher.

These and other aspects of the invention are described in the detailed description below. In no event should the above summary be construed as a limitation on the claimed subject matter.

### BRIEF DESCRIPTION OF THE DRAWINGS

The accompanying drawings are included to provide a further understanding of the invention described herein and are incorporated in and constitute a part of this specification. The drawings illustrate exemplary embodiments. Certain features may be better understood by reference to the following detailed description when considered in connection with the accompanying drawings, in which like reference numerals designate like parts throughout the figures thereof, and wherein:

FIG. 1 is a perspective view of an exemplary fluid filtration system;

FIG. 2 is a perspective view of another exemplary fluid filtration system;

FIG. 3 is an exploded perspective view of another exemplary fluid filtration system; and

FIG. 4 is an exploded perspective view of another exemplary fluid filtration system.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

Provided are fluid filtration systems that have openings in their sump closures. Spouts for processed fluid may be added to direct flow of processed fluid. The spouts may be attached, permanently or removably, to the sump closures or to media cartridges. The systems in general comprise: an inlet for unprocessed fluid, i.e., water along with both an unprocessed fluid outlet and a processed fluid outlet. A sump housing and a sump closure operatively associated therewith contain a media cartridge. The processed fluid outlet is located through the sump closure. A diverter having two or more positions, permits receipt of either unprocessed fluid or processed fluid from the system.

The following terms shall have, for the purposes of this application, the respective meanings set forth below.

“Fluid path” refers to a substantially continuous route of a fluid into, through, and/or out of a media element.

A “media element” refers to structures that are formed by one or more types of media to achieve filtration and/or treatment of a fluid. The media may provide functionalities including, but not limited to, mechanical filtration, ion exchange, and/or adsorptive capacity.

“Processed fluid” refers to fluid that has contacted a media element to achieve a desired result, such as filtering and/or treatment as described herein.

A “media cartridge” comprises a media element and structures such as end caps to ensure flow of fluid to be processed through the media and out of the cartridge as processed fluid. In some instances, there is a core or other passage internal to the media element of the cartridge for fluid flow. A specific media cartridge is a filter cartridge.

By “end cap” it is meant a substantially solid piece of material placed at the end of a media block which is dimensioned so as to at least seal the greater portion of the surface area of one or both ends of the block. End caps on either end of a media cartridge may independently have additional features to facilitate installation and/or use of the media cartridge.

“Filtered fluid” refers to fluid that has contacted a separation media to achieve a desired purity. For example, fluid filtered by a carbon-based filter block that contains separation media may achieve a reduction in sediment, chlorine, and lead.

“Unfiltered fluid” fluid that bypasses treatment by a separation media. Both filtered and unfiltered fluid may be treated as needed by contact with a treatment media.

“Treated fluid” refers to fluid that has contacted a treatment media to achieve a desired treatment. For example, fluid treated by a weak acid cation (WAC) exchange resin may achieve a reduction in hardness.

“Untreated fluid” fluid that bypasses treatment by a treatment media. Both treated and untreated fluid may be purified as needed by a filter such as a carbon-based filter.

The terms “treatment media” and “adsorptive media” include materials (called adsorbents) having an ability to adsorb particles via different adsorptive mechanisms. These media may be in the form of, for example, spherical pellets, rods, fibers, molded particles, or monoliths with hydrodynamic diameter between about 0.01 to 10 mm. If such media is porous, this attribute results in a higher exposed surface area and higher adsorptive capacity. The adsorbents may have combination of micropore and macropore structure enabling rapid transport of the particles and low flow resistance.

A “spout” is a conduit that directs processed fluid out of a media cartridge or the sump housing/closure directly to the atmosphere. Usually, the spout only has an opening for flow of processed fluid out and does not connect to any further tubing or conduits to reach the atmosphere, and it does not have an opening to receive unprocessed fluid for contacting media. The spout is operatively associated, or attached, to an element of the fluid filtration system as needed. Reference to “attached” means that there is a connection between the spout and, for example, the sump closure or one of the end caps of the media cartridge. That connection may be permanent as a result of integral formation by, for example, injection molding the two items at the same time. Or the connection may be removable by, for example, a snap-fit or a threaded connection, or even a lightly adhesive connection, between the two separately fabricated items. One aspect of the spouts is that they may be disposable in order to periodically provide new and unused spouts to deliver the processed fluid/water.

A “nozzle” is a particularly shaped spout, such as one that is tapered.

A “bridge” is a structure that resides between a faucet connection and a housing of the sump, providing one or more passages for water/fluid flow, for example, into the sump from the faucet and to an unprocessed fluid outlet. In one form, a bridge may comprise one or more hoses or pieces of tubing. In other forms, the bridge may be a polymeric structure with one or more passages therein. A rotatable structure of the bridge permits positioning of the processed fluid outlet to any desired location, depending on the application. When hoses or tubing are used, they themselves are the rotatable structure. When a polymeric structure is used, the rotatable structure may be a movable joint such as a swivel joint.

### Media Elements

Examples of suitable media may include cellulosic media, synthetic media, or a combination thereof. Media elements may be formed by one or more types of media. Media elements with additional structures for media cartridges that provide processed fluid upon contact with unprocessed fluid. Media that may be used individually or in any combination are provided in the following.

The media may be particles contained loosely or particles formed into a media block. Exemplary particles for use as media include, but are not limited to: activated carbon, polymeric binder, diatomaceous earth, and ion exchange resin. For example, media comprising activated carbon and polymeric binder particles may form a carbon-based filter block. Another example is media comprising charge-modified resin for ion exchange purposes.

In addition, media may include structures, pleated or unpleated, including, but not limited to: a woven structure, a non-woven structure, a microporous membrane, a monolith, a melt-blown fiber (MBF) structure, and an open-cell foam. Exemplary materials of construction of these structure may include, but are not limited to: nylon (e.g., nylon 6,6), ethylene chlorotrifluoroethylene (ECTFE), polypropylene, polyethylene, polyvinylidene fluoride (PVDF), polyethersulfone, polysulfone, polyester, polytetrafluoroethylene (PTFE), polycarbonate, nitrocellulose, cellulose acetate, cellulose, or combinations thereof.

Exemplary media elements may be: a pleated microporous membrane, a carbon-based filter block, ion-exchange resin alone or located in a core of a filter block, a hollow-fiber membrane, a nonwoven material wrapped around a filter block, and any combination thereof.

### Uses

The fluid filtration systems disclosed herein are attached to faucets, usually located in consumers' kitchens, to provide processed water for the consumers' needs. The consumer, in purchasing such a device, may be interested in one or more of the following characteristics: sediment, taste, flavor enhancement, odor, volatile organic components (VOCs), lead, cyst, and the like. Choice of a media cartridge permits addressing any desired filtration and purity goals.

With respect to the use of spouts in these systems, the spouts may be removably attached to a component of the system, for example, an end cap of the media cartridge or to the sump closure. The spouts may be disposable, with the opportunity to replace them whenever the consumer wants, for example, when the media cartridge is being replaced. The spout itself may be shaped, for example, as a nozzle, and designed without limit to provide ease of obtaining processed water and ease of replacement. Attaching the spout may also be done in convenient ways such as by twist or snap-on or with a light adhesive.

Structurally, these systems may also be tailored to customize the direction of processed water delivery by the presence of a rotatable structure. Providing a bridge that is rotatable permits angling of the flow of processed water to any desired location. For traditional use, the processed water flow is directed towards the kitchen sink, in the same direction as the unprocessed water flow. In the opposite position, where the processed water flow would be in a direction opposite that of the unprocessed water flow, the system may be disassembled for media cartridge and/or spout replacement. In this location, the consumer can see how to remove the spent cartridge and install a new one. Also, in this way, water from the sump housing will not spill during disassembly. Once the spent cartridge is removed, the housing may be rotated as needed to empty it out then rotated to a suitable angle for insertion of a new cartridge. In addition, the spent media cartridge, which may have sediment (fine silt) or slime (biomass) on its outside surface, can be easily removed by grasping the bottom end cap while avoiding the sediment and slime.

For a different use, the processed water flow may be angled at any desired position to achieve the effect of a water fountain.

In addition, fluid filtration systems for faucets may be easily maintained through regular cleaning and sanitizing by disassembling it from the faucet and/or removing any of its components. The entire system and/or individual components may be cleaned or replaced as needed. For example, it is beneficial to periodically replace the media cartridge and/or spouts. It may also be possible to clean and sanitize these components prior to replacing them. In some instances, it may be beneficial to clean and sanitize with heat only in the absence of cleaners or soap products. For example, heat cleaning and/or sanitizing may be achieved by any of the following: contacting the fluid filtration system with hot water from the faucet, placing the fluid filtration system in boiling water, and putting the fluid filtration system through a cycle of a dishwasher. In other instances, cleansers and soap products may be used for surface cleaning of the exterior surfaces. With exposure to heat, some of the VOC capacity and other functionalities of the media may be regenerated. After cleaning and/or sanitizing, the fluid filtration system is reinstalled and/or the components are reassembled.

Before describing several exemplary embodiments of the invention, it is to be understood that the invention is not limited to the details of construction or process steps set forth in the following description. The invention is capable of other embodiments and of being practiced or being carried out in various ways.

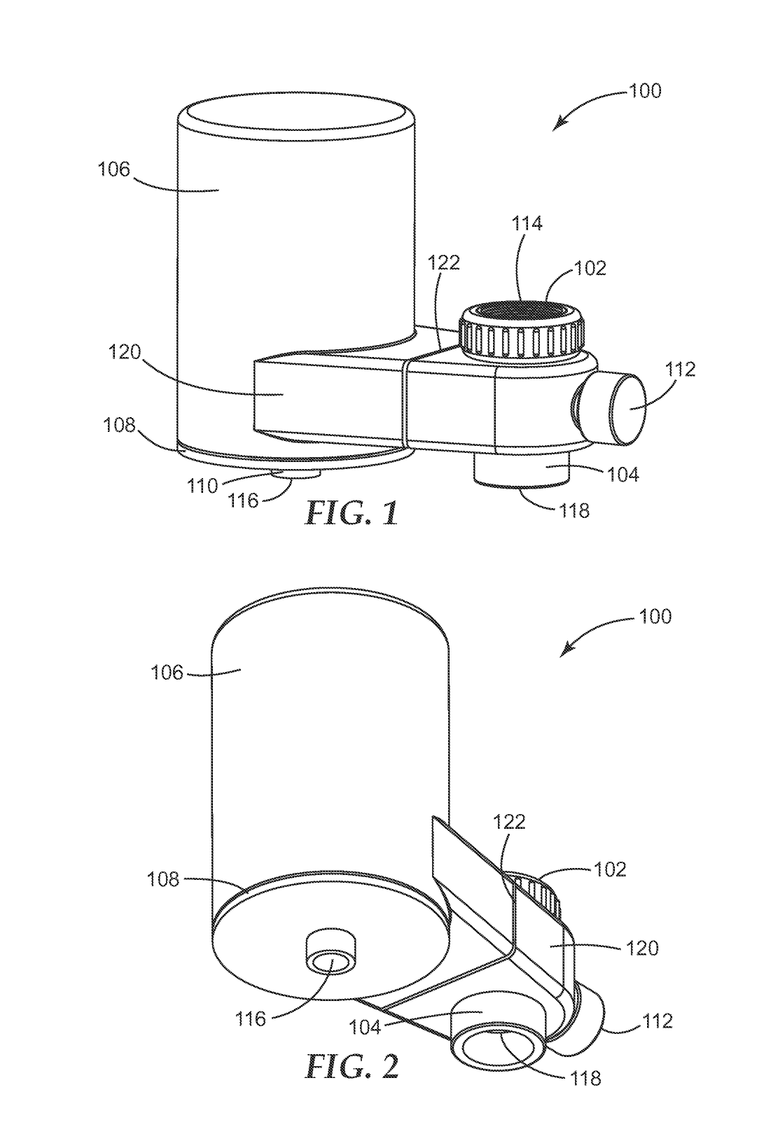

Turning to the figures, FIG. 1 provides a perspective view of an exemplary fluid filtration system 100 comprising faucet connection 102, an inlet 114, a processed fluid outlet 116, an unprocessed fluid outlet 118, and a bridge 120 that provides fluid passage from the inlet 114 to sump housing 106 and/or the unprocessed fluid outlet 118. The sump housing 106 is closed with sump closure 108 such that a sealed unit is achieved, which permits fluid to only exit through the processed fluid outlet 116. An unprocessed fluid spout 104 directs the flow of unprocessed fluid, that is, fluid that does not contact a media element. Typically, water flows downward from the faucet into inlet 114 and the flow out of the unprocessed fluid spout is in the same downward direction. This, however, may be changed according to consumers' needs. A processed fluid spout 110 directs flow of the processed fluid. In traditional use, the flow of the processed fluid is downward, but with the presence of an optional rotatable structure 122, in this instance, a rotatable joint, the processed fluid flow may be directed at any desired angle. The spout may be shaped and sized to accommodate the use of the filtration system as a water fountain.

The sump housing 106 and the sump closure 108 are operatively associated, which means the sump closure and sump housing form a unit that is operable to house a media cartridge in a water-tight manner.

A diverter 112, in a first position, directs unprocessed fluid to the unprocessed fluid outlet 118, and in a second position, directs processed fluid to the processed fluid outlet 116.

FIG. 2 provides a perspective view of another exemplary fluid filtration system 100 without a processed fluid spout. Here, the system 100 comprises faucet connection 102, an inlet (not shown), a processed fluid outlet 116, an unprocessed fluid outlet 118, and a bridge 120 that provides fluid passage from the inlet to sump housing 106 and/or the unprocessed fluid outlet 118. The sump housing 106 is closed with sump closure 108. An unprocessed fluid spout 104 directs the flow of unprocessed fluid. An optional rotatable structure 122, in this instance, a rotatable joint, permits the processed fluid flow to be directed at any desired angle. A diverter 112, in a first position, directs unprocessed fluid to the unprocessed fluid outlet 118, and in a second position, directs processed fluid to the processed fluid outlet 116.

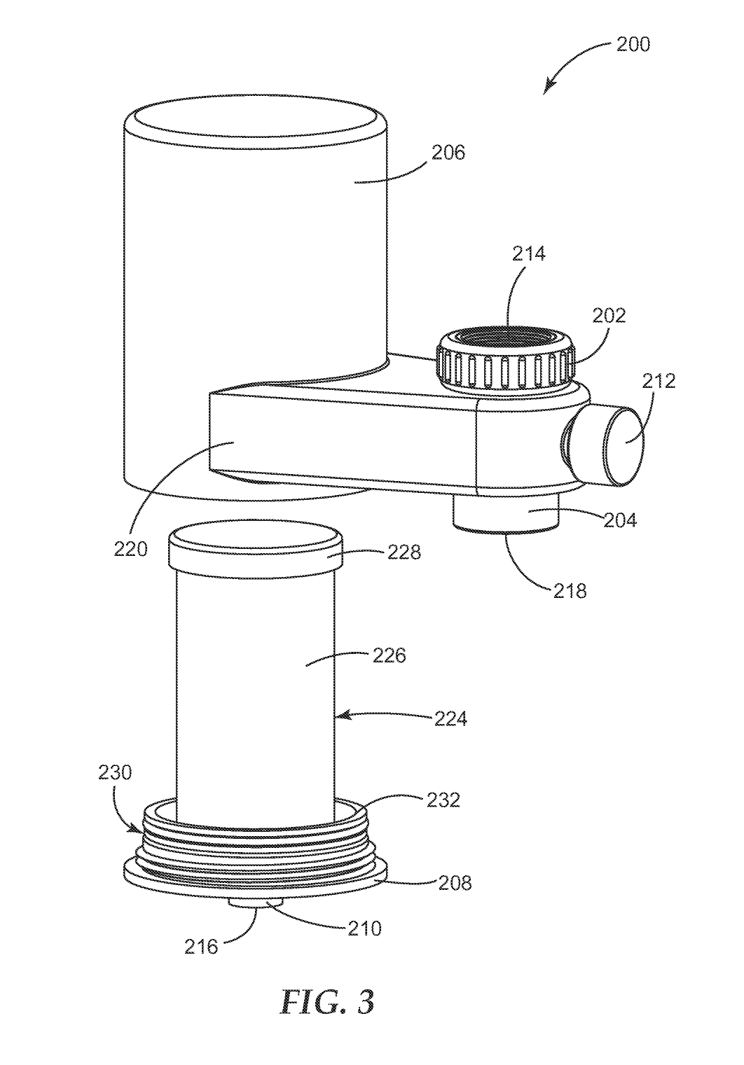

FIG. 3 provides an exploded perspective view of another exemplary fluid filtration system 200. Here, the system 200 comprises faucet connection 202, an inlet 214, a processed fluid outlet 216, an unprocessed fluid outlet 218, and a bridge 220 that provides fluid passage from the inlet 214 to sump housing 206 and/or the unprocessed fluid outlet 218. The sump housing 206 is closed with sump closure 208 having the processed fluid outlet 216. In this embodiment, media cartridge 224 comprises media block 226, a first end cap 228, and a second end cap 230, where the second end cap 230 comprises the sump closure 208 and a sealing mechanism 232. The processed fluid spout 210 in fluid communication with the processed fluid outlet 216 is also part of the second end cap 230 and sump closure 208. That is, for fabricating purposes, there may be individual components: processed fluid spout 210, sealing mechanism 232, and sump closure 208 that are affixed to each other. Or, two of these components (i.e., the sump closure and the sealing mechanism) may be integrally formed by, for example, injection molding and the third component (i.e., the processed fluid spout) is later attached. Or, all three components may be integrally formed into one end cap structure.

Unprocessed fluid spout 204 directs the flow of unprocessed fluid. A diverter 212, in a first position, directs unprocessed fluid to the unprocessed fluid outlet 218, and in a second position, directs processed fluid to the processed fluid outlet 216.

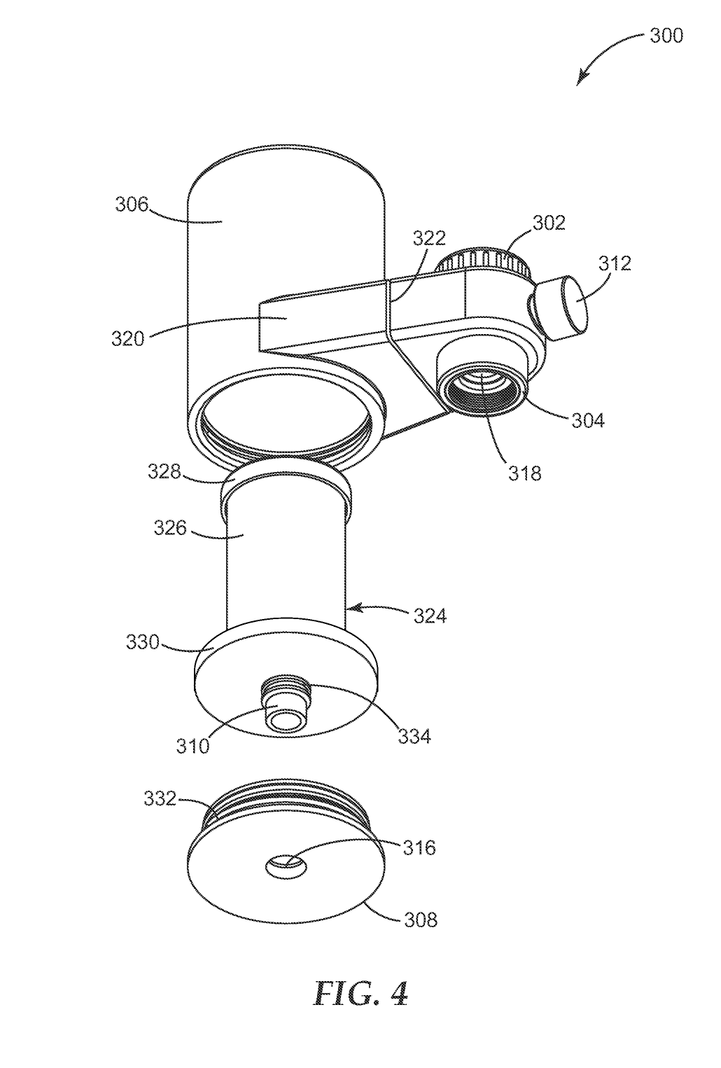

In FIG. 4, an exploded perspective view of another exemplary fluid filtration system 300 is provided. System 300 comprises faucet connection 302, an inlet (not shown), a processed fluid outlet 316, an unprocessed fluid outlet 318, and a bridge 220 that provides fluid passage from the inlet to sump housing 306 and/or the unprocessed fluid outlet 318. The sump housing 306 is closed with sump closure 308. In this embodiment, media cartridge 324 comprises media block 326, a first end cap 328, and a second end cap 330, where the second end cap 330 comprises a seal 334, such as an o-ring seal, and processed fluid spout 310. For fabricating purposes, the processed fluid spout 310 may be integral with the body of the second end cap 330 or it may be removable. The sump closure 308 defines the processed fluid outlet 316 and it also comprises sealing mechanism 332. The processed fluid spout 310 fits through the processed fluid outlet 316 upon assembly.

Unprocessed fluid spout 304 directs the flow of unprocessed fluid. Optional rotatable structure 322 permits positioning of the system as discussed previously. A diverter 312, in a first position, directs unprocessed fluid to the unprocessed fluid outlet 318, and in a second position, directs processed fluid to the processed fluid outlet 316.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A fluid filtration system for a faucet, the system comprising:
an inlet, an unprocessed fluid outlet, and a processed fluid outlet;
a sump housing and a sump closure operatively associated therewith, the processed fluid outlet being located through the sump closure;
a media cartridge located in the sump housing, the media cartridge providing processed fluid upon contact with unprocessed fluid; and
a diverter having a first position where the inlet is in fluid communication with the unprocessed fluid outlet, and a second position where in the inlet is in fluid communication with the processed fluid outlet.

2. The fluid filtration system of claim 1 further comprising a processed fluid spout that directs flow of processed fluid.

3. The fluid filtration system of claim 1, wherein the sump closure is attached to a media element of the media cartridge.

4. The fluid filtration system of claim 1 comprising a media cartridge that comprises a media element, a first end cap sealed to the media element, and a second end cap comprising the sump closure sealed to the media element and comprising a sealing mechanism that operatively engages with the sump housing.

5. The fluid filtration system of claim 2, wherein the processed fluid spout is attached to the sump closure and defines the processed fluid opening.

6. The fluid filtration system of claim 5, wherein the processed fluid spout is integrally attached to the sump closure.

7. The fluid filtration system of claim 5, wherein the processed fluid spout is removably attached to the sump closure.

8. The fluid filtration system of claim 2, wherein the processed fluid spout is attached to the media cartridge.

9. The fluid filtration system of claim 8, wherein the processed fluid spout is integrally attached to an end cap of the media cartridge.

10. The fluid filtration system of claim 8, wherein the processed fluid spout is removably attached to an end cap of the media cartridge.

11. The fluid filtration system of claim 1 comprising a media cartridge that comprises the media element, a first end cap sealed to the media element, and a second end cap sealed to the media element and comprising a processed fluid spout, and wherein the sump closure comprises a sealing mechanism that operatively engages with the sump housing.

12. The fluid filtration system of claim 1 further comprising a bridge between the faucet connection and the sump housing.

13. The fluid filtration system of claim 12, wherein the bridge comprises a rotatable structure to permit positioning of the sump housing to a first position where flow of processed fluid from the processed fluid outlet is in the same direction as flow of unprocessed fluid from the unprocessed fluid outlet, or to a second position where flow of processed fluid from the processed fluid outlet is in the opposite direction as flow of unprocessed fluid from the unprocessed fluid outlet, or to a third position located at any angle between the first position and the second position.

14. The fluid filtration system of claim 2, wherein the processed fluid spout is removably attached to the sump closure or to the media cartridge, and is disposable.

15. The fluid filtration system of claim 2, wherein the processed fluid spout comprises a movable joint that permits adjusting the direction of the flow of the processed fluid.

16. A media cartridge for use in a sump housing of a fluid filtration system for a faucet, the media cartridge comprising:
a media element;
a first end cap sealed to the media element;
a second end cap comprising a sump closure sealed to the media element, a processed fluid outlet, and a sealing mechanism that operatively engages with a sump housing upon installation into the fluid filtration system.

17. The media cartridge of claim 16, wherein the media element comprises a carbon-based filter block wrapped with a nonwoven layer of media.

18. The media cartridge of claim 16 further comprising a processed fluid spout in fluid communication with the processed fluid opening.

19. The media cartridge of claim 16, wherein the processed fluid spout is removable.

20. A method for providing a processed fluid, the method comprising:
flowing an unprocessed fluid through a filtration system of claim 1; and
obtaining the processed fluid from the filtration system.

21. The method of claim 20, further comprising attaching a processed fluid spout to the sump closure or to the media cartridge.

22. The method of claim 21, further comprising detaching the processed fluid spout from the sump closure or to the media cartridge.

23. The method of claim 20, wherein the fluid filtration system further comprises a bridge between the faucet connection and the sump housing, the bridge comprising a rotatable structure.

24. The method of claim 23 further comprising positioning the sump housing to a first position a first position where flow of processed fluid from the processed fluid outlet is in the same direction as flow of unprocessed fluid from the unprocessed fluid outlet.

25. The method of claim 23 further comprising positioning the sump housing to a second position where flow of processed fluid from the processed fluid outlet is in the opposite direction as flow of unprocessed fluid from the unprocessed fluid outlet.

26. The method of claim 23 further comprising positioning the sump housing to an angle relative to the direction of flow of unprocessed fluid from the unprocessed fluid outlet.

27. The method of claim 21, wherein the spout further comprises a movable joint and the method further comprises positioning the spout to adjust the direction of the flow of processed fluid.

28. The method of claim 20, further comprising:
locating in the sump housing: the media cartridge that comprises a media element, a first end cap sealed to the media element, and a second end cap comprising the sump closure sealed to the media element, and comprising a sealing mechanism; and
operatively engaging the sealing mechanism with the sump housing.

29. The method of claim 20, further comprising:
locating in the sump housing: the media cartridge that comprises a media element, a first end cap sealed to the media element, and a second end cap sealed to the media element and comprising a processed fluid spout;
installing the sump closure, which further comprises a sealing mechanism, such that the processed fluid spout extends through the process fluid outlet; and
operatively engaging the sealing mechanism with the sump housing.

30. A method of making a fluid filtration system, the method comprising:
obtaining a sump housing and a sump closure operatively associated therewith, the sump closure comprising a processed fluid outlet therethrough and a sealing mechanism;
locating a media cartridge comprising a media element, a first end cap, and a second end cap in the sump housing; and
engaging the sealing mechanism with the sump housing.

31. The method of claim 30, wherein the sump closure and the sealing mechanism form the second end cap.

32. The method of claim 30, wherein the sump closure comprises the sealing mechanism and the second end cap further comprises a processed fluid spout.

33. A method of maintaining a fluid filtration system of a faucet, the method comprising:
disassembling the fluid filtration system from the faucet and/or removing components from the fluid filtration system;
cleaning and/or sanitizing the fluid filtration or any of the components; and
reinstalling the fluid filtration system with the faucet and/or reassembling the components of the fluid filtration system.

34. The method of claim 33, wherein the cleaning and/or sanitizing step is conducted by any of the following: contacting the fluid filtration system with hot water from the faucet, placing the fluid filtration system in boiling water, and putting the fluid filtration system through a cycle of a dishwasher.

35. A media cartridge for use in a sump housing of a fluid filtration system for a faucet, the media cartridge comprising:
a media element;
a first end cap sealed to the media element;
a second end cap sealed to the media element and comprising a processed fluid spout and a seal that operatively engages with a processed fluid outlet of a sump closure upon installation into the fluid filtration system.

36. The media cartridge of claim 35, wherein the media element comprises a carbon-based filter block wrapped with a nonwoven layer of media.

37. The media cartridge of claim 35, wherein the processed fluid spout is removable from the second end cap.
